(19) United States
(12) Patent Application Publication
(10) Pub. No.: US 2016/0244102 A1
(43) Pub. Date: Aug. 25, 2016

(54) COUPLING MEMBER

(71) Applicant: TOYODA IRON WORKS CO., LTD., Toyota-shi (JP)

(72) Inventor: Shimpei CHIKADA, Toyota-shi (JP)

(73) Assignee: TOYODA IRON WORKS CO., LTD., Toyota-shi (JP)

(21) Appl. No.: 15/052,008

(22) Filed: Feb. 24, 2016

(30) Foreign Application Priority Data
Feb. 25, 2015 (JP) 2015-034743

(51) Int. Cl. B62D 25/08

(52) U.S. Cl. CPC B62D 25/08

(57) ABSTRACT

First and second cover sections 53 and 55 of a coupling member 51 are connected to each other at a branching section where a cowl side 11 and a lower member 19 are joined, by a concave portion 56 inserted into a groove section 23 which is the inner side portion of a branch. A concave portion 56 connects a side edge portion 53A on the side of the groove section 23 in the first cover section 53 and a side edge portion 55A on the side of the groove section 23 in the second cover section 55. A coupling member 51 closes an opening of the groove section 23 by the concave portion 56 which connects the first and second cover sections 53 and 55. Therefore, the coupling member 51 is able to fix the branching section more firmly which couples frame members of a vehicle to each other.

### CROSSREFERENCE TO RELATED APPLICATIONS

This application is based upon and claims the benefit of priority of the prior Japanese Patent Application No. 2015-034743, filed on Feb. 25, 2015, the entire contents of which are incorporated herein by reference.

### FIELD OF THE INVENTION

The present invention relates to a coupling member which couples members for use in frames of vehicles.

### BACKGROUND

Conventionally, a technique has been disclosed in which a cowl side and a front side member are coupled as a frame structure of a vehicle front section of an automobile (Patent

Document 1: Japanese Unexamined Patent Application Publication No. 2010-64638). In the frame structure disclosed in Patent Document 1, a sheet metal joining body is provided which couples a front side member which extends in the front-back direction at the lower section of the vehicle body front section to a cowl side which protrudes frontward from a front pillar. In this type of frame structure for automobile, for example, a structure is adopted in which, when the vehicle front section collides with an object and the impact therefrom is applied to the front side member, a plurality of members branched variously propagates the applied impact to other frame members (a cowl side, etc.).

For example, as shown in FIG. 11, a cowl side 101 is joined by welding to upper surfaces 203 and 205 of a front side member 201. The upper surface 205 is bent at a predetermined angle to the upper surface 203. In addition, a mark “X” in the figure indicates a welding portion by spot welding as an example. A tip end portion of the cowl side 101 is provided with flange sections 103 and 105, and the flange sections 103 and 105 are joined by spot welding to the upper surfaces 203 and 205 of the front side member 201, respectively. The cowl side 101 is formed of, for example, a metal plate material bent in a substantially U-shape. The flange section 103 is formed at a tip end of a first side plate 107, and the flange portion 105 is formed at a tip end of a second side plate 109 orthogonal to the first side plate 107. A notch 111 is formed between the flange portion 103 and the flange portion 105.

The notch 111 is, for example, a notch portion which is formed in the light of formability in order to prevent the section between the flange portions 103 and 105 from being deformed or cracking at the time of bending and forming the cowl side 101 so as to bend the second side plate 109 with respect to the first side plate 107, followed by bending the tip end concerned to form the flange sections 103 and 105.

### SUMMARY OF THE INVENTION

For example, as indicated by an arrow 301 in the figure, when a load is applied from the front side of the vehicle to the rear side so that the impact propagates from the front side member 201 to the cowl side 101, a force is applied concentrically on the periphery of the notch 111, particularly on a base portion 111A of the notch 111 where the flange portions 103 and 105 intersect. As a result, cracks and deformation may occur in the notch 111, thereby decoupling the cowl side 101 from the front side member 201.

In view of foregoing, the technique disclosed in the present application is offered. The object thereof is to provide a coupling member capable of fixing a branching section more firmly which couples frame members of a vehicle to each other.

A coupling member of according to an aspect of the present invention is the coupling member of vehicle frame for coupling a first member extending in the first direction to a second member extending in the second direction different from the first direction, comprising: a first cover section covering the first member; a second cover section covering the second member; and a concave portion connecting two side edge portions, that is, a first side edge portion and a second side edge portion, in a branching section coupling the first member to the second member, wherein the concave portion inserted in an inner portion of a branch sandwiched between the first and second members, the first side edge portion provided in the first cover section and provided at the position as being an inner side portion of the branch in the width direction of the first member, the second side edge portion provided in the second cover section and provided at the position as being an inner side portion of the branch in the width direction of the second member.

In the coupling member, the first and second members are coupled while the first member is covered with the first cover section and the second member is covered with the second cover section. The first and second cover sections are connected to each other at the branching section by the concave portion inserted into the inner side portion of the branch. The concave portion connects the first side edge portion as being the inner side portion of the branch in the first cover section to the second side edge portion as being the inner side portion of the branch in the second cover section. In such a structure, since the first member and the second member are coupled by the coupling member, it becomes unnecessary to provide a flange portion which is any of first or second member (such as a cowl side) with a notched portion that is conventionally used. Furthermore, in the coupling member concerned, it is possible to close the portion corresponding to the notched portion in the conventional structure by the concave portion which connects the first and second cover sections at the inner side portion of the branch. Therefore, even if a load by an impact or the like in the direction away from the second cover section is applied to the first cover section, for example, the impact applied from the first side edge portion of the first cover section toward the second side edge portion of the second cover section is transmitted via the concave portion, so that the load to be applied is not applied concentrically to the point at which the first cover section and the second cover sections intersect with each other. Therefore, it is possible to prevent the branching section from being deformed or cracking, resulting in separation of the first member and the second member. Consequently, it is possible to fix the first member and the second member more firmly by the coupling member.

The coupling member according to another aspect of the present invention is the coupling member according to claim 1, wherein the concave portion is formed in a flat plate shape, and has a bottom section to be joined to at least one of the first and second members.

In the coupling member concerned, the concave portion is joined to at least one of the first and second members by the bottom section. For example, if the fixing plate portion corresponding to a flat-shaped bottom section is provided in the first member, the fixing plate portion of first member and the bottom section of the concave portion can be joined by spot welding while overlapping each other. This makes it easier to join the concave portion to the first and second members. In other words, the coupling member makes it possible to easily and firmly fix the first member and the second member.

The coupling member according to another aspect of the present invention is the coupling member according to claim 1, wherein the concave portion has an inclining section gradually inclining toward the depth direction in the inner portion of the branch as it is closer from a basal portion side of the branch to a ramification side.

The coupling member concerned makes it easily to forming by press working. For example, the metal plate material put on the lower die is press worked using the upper die corresponding to the shape of the inclining section, so that it becomes possible to easily form the concave portion which is formed continuously to the first cover section and the second cover section. Thereby, it becomes possible to reduce cost for manufacturing the coupling member capable of coupling the first member and the second member more firmly.

The coupling member according to another aspect of the present invention is the coupling member according to claims 1, comprising: a first outer wall section connected to the first cover section, and covering the outer periphery of the first member in the outer section of the branch; and a second outer wall section connected to the second cover section, and covering the outer periphery of the second member in the outer section of the branch.

The coupling member concerned is provided with the first and second outer wall sections which cover the outer periphery of each of the first and second member. Therefore, for example, the first and second outer wall sections are joined by welding or the like to the outer periphery respestively, so that it becomes possible to fix the coupling member to the first and second members more firmly. In other words, the first and second members are coupled more firmly by the first and second outer wall sections.

The coupling member according to another aspect of the present invention is the coupling member according to claims 1, wherein the concave portion for connecting the first cover section and the second cover section is formed from a fan-shaped metal plate material by press working without fixing an arc-shaped portion of the fan-shaped metal plate material.

In the section where the frame members of a vehicle, such as a cowl side or a front side member, the branching section makes a variety of angles, some of which are often sharp, for example. In such a case, in the coupling member which couples the first member having an sharp angle to the second member, if it is intended to provide the concave portion to be inserted into the branching section deeper, the angle of the concave portion becomes acute. At the time of forming the coupling member by press working, for example, it is necessary to stretch a part of the metal plate material while fixing the metal plate material to the lower die or the like so as to form an acute concave portion by drawing or the like. This is, however, not an easy way to form. Then, in the press working of the coupling member concerned, a fan-shaped metal plate material is depressed by press working without fixing an arc-shaped portion. In this method for forming, the metal plate material is moved so as to be pulled toward the portion to be depressed, and the section to be depressed by press working is stretched so that the concave portion having a desired depth is formed. This makes it possible to manufacture the concave portion having an sharp angle with high accuracy, and, for example, the first and second members making the branching section of the sharp angle can be fixed firmly by the coupling member. Here, it can be considered that the concave portion is joined to the first and second cover sections by welding or the like, for example, however, such as structure is intended to provide the weaker strength at the section joined by welding or the like. In contrast, in the coupling member concerned, it is possible to form the first cover section, the second cover section, and the concave portion integrally by a metal plate material, thereby joining the first and second cover sections and the concave portion more firmly.

### BRIEF DESCRIPTION OF THE DRAWINGS

FIG. 1 is a perspective view showing a part of a frame structure of a vehicle front section of a vehicle in which frame members are coupled by a coupling member of Embodiment 1.

FIG. 2 is an enlarged view of a portion where the coupling member is provided in FIG. 1.

FIG. 3 is a cross sectional view showing a cross section taking a line A-A in FIG. 2 seeing from the direction of an arrow.

FIG. 4 is a cross sectional view corresponding to FIG. 3 for explaining joining state in another example of Embodiment 1.

FIG. 5 is an enlarged view of a portion where a coupling member is provided in Embodiment 2.

FIG. 6 is a cross sectional view showing a cross section taking a line B-B in FIG. 5 seeing from the direction of an arrow.

FIG. 7 is a plan view of a metal plate material for explaining a method for manufacturing a coupling member.

FIG. 8 is a perspective view showing a state of press working for explaining a method for manufacturing a coupling member.

FIG. 9 is a perspective view showing a state of press working for explaining a method for manufacturing a coupling member.

FIG. 10 is a perspective view for explaining a method for manufacturing a coupling member.

FIG. 11 is a perspective view for explaining a state of joining frame members of a vehicle of a comparative embodiment.

### DETAILED DESCRIPTION OF THE PREFERRED EMBODIMENTS

### Embodiment 1

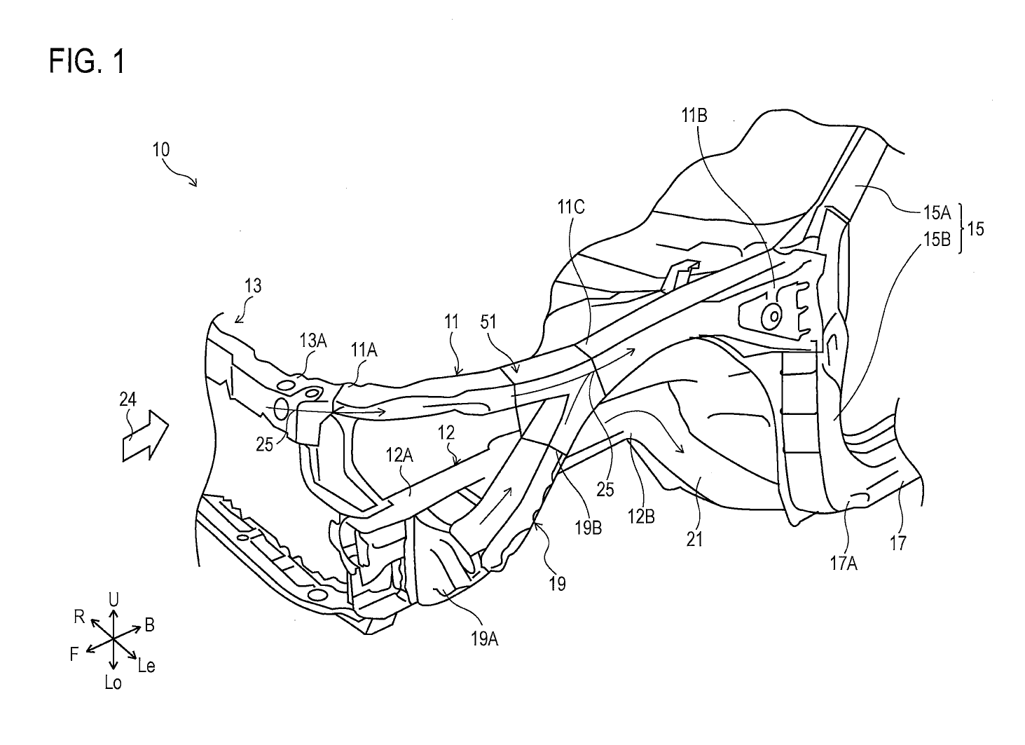

Description will be given below as an example of a frame structure for a vehicle in a case where a coupling member according to the present invention is applied to a structure of a vehicle front section. FIG. 1 shows a part of a frame in a front section of a vehicle 10 according to Embodiment 1. The front-back (F means the forward direction and B means the backward direction in FIG. 1) direction shown in the figure indicates the traveling direction of the vehicle. Furthermore, the right-left (R means the rightward direction and Le means the leftward direction in FIG. 1) direction indicates the vehicle width direction of the vehicle 10 which travels forward and/or backward. Therefore, FIG. 1 shows a part of a frame on the left side of the vehicle width direction in the vehicle front section.

As shown in FIG. 1, the vehicle 10 is provided with a cowl side 11, a front side member 12, etc. The cowl side 11 is provided so as to extend in the front-back direction on the upper side of the front section of the vehicle 10. A front end section 11A of the cowl side 11 is bent toward the vehicle width direction (rightward (R) in the figure), and joined to an upper frame 13 at a bent portion thereof. The upper frame 13 is provided so as to extend in the vehicle width direction on the upper portion of the front section of the vehicle 10. An end section 13A in the vehicle width direction of the upper frame 13 is joined to the front end section 11A of the cowl side 11.

A rear end section 11B of the cowl side 11 is joined to a front pillar 15. The front pillar 15 is provided with a front pillar upper 15A which extends downward toward the front direction from a roof, and a front pillar lower 15B which extends downward from the front end of the front pillar upper 15A to continue to front end section 17A of a side sill 17. The rear end section 11B of the cowl side 11 is joined to a front end of the front pillar upper 15A, and is joined to a portion to be an upper end of the front pillar lower 15B. Consequently, the cowl side 11 is provided so as to protrude forward from the intermediate portion in the upper-lower (U means the upperward direction and Lo means the lowerward direction in FIG. 1) direction of the front pillar 15.

Furthermore, the front side member 12 is provided so as to extend in front-back direction on the lower side of the front section of the vehicle 10. A front end section 12A of the front side member 12 is joined to a lower member 19. The lower member 19 is a member for coupling the cowl side 11 to the front side member 12. The lower member 19 is provided on the outside of the front side member 12 in the vehicle width direction, and extends in the upper-lower direction of the vehicle 10. The front end section 12A of the front side member 12 is joined to a lower end section 19A of the lower member 19 which is located on the outside of the vehicle width direction.

Furthermore, the rear end section 12B of the front side member 12 is joined to an outrigger 21. The outrigger 21 is provided so as to extend in the vehicle width direction on the vehicle lower section, and each of the ends in the vehicle width direction is joined to the inner side portion of a side sill 17

An upper end section 19B of the lower member 19 is joined to an intermediate portion 11C of the cowl side 11 extending in the front-back direction of the vehicle 10. The upper end section 19B is coupled to the lower side portion of the intermediate portion 11C. An coupled section where the cowl side 11 and the lower member 19 are coupled to each other is provided with a coupling member 51. A section where the cowl side 11 and the lower member 19 are coupled by the coupling member 51 is substantially Y-shaped when viewed from the outside of the vehicle width direction of the vehicle 10.

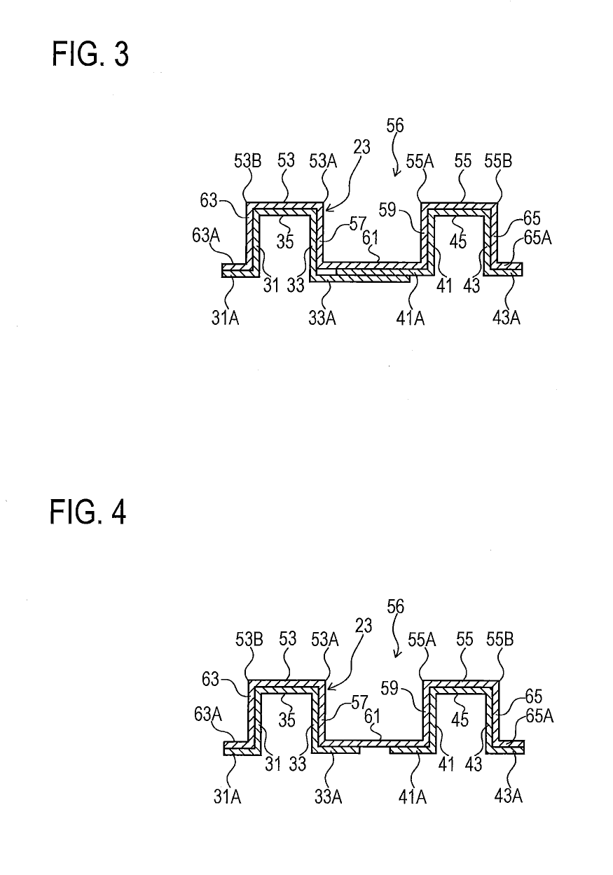

The frame members, such as the cowl side 11, etc., of the vehicle 10 described above are formed, for example, by press-working a metal plate material in the shape of bottomed box in which is opened by removing one of the inner or outer side walls of the vehicle width direction (see FIG. 3). In addition, the cowl side 11 or the like may have the shape of bottomed box which is opened by removing an upper wall or a lower wall located in the upper-lower direction of the vehicle 10, or may have the shape in which a rear wall on the rear side of the vehicle 10 is omitted. Furthermore, the cowl side 11 or the like may be, for example, in the shape of a rectangular parallelepiped box. Furthermore, the cowl side 11 or the like may not have a hollow structure, and may be a member inside of which is formed to be dense. Furthermore, the cowl side 11 or the like may be in the polygonal cylindrical shape, or may be in the circular cylindrical shape such as circle, ellipse, etc.

Here, for example, when an impact by an collision or the like is applied from the front of the vehicle as shown by an arrow 24 in FIG. 1, the frame structure of the vehicle 10 having the structure described above dispersedly transmits the applied impact to the cowl side 11, the front side member 12, or the like, so as to absorb the impact, as shown by an arrow 25 in FIG. 1. The vehicle 10 is structured to disperse the impact to the front pillar 15 or the side sill 17 depending on the magnitude of the applied impact so as to absorb the impact with high efficiency. For this reason, in order to transmit and disperse the applied impact with certainty, a member for fixing the coupled section, such as the coupling member 51, becomes more important.

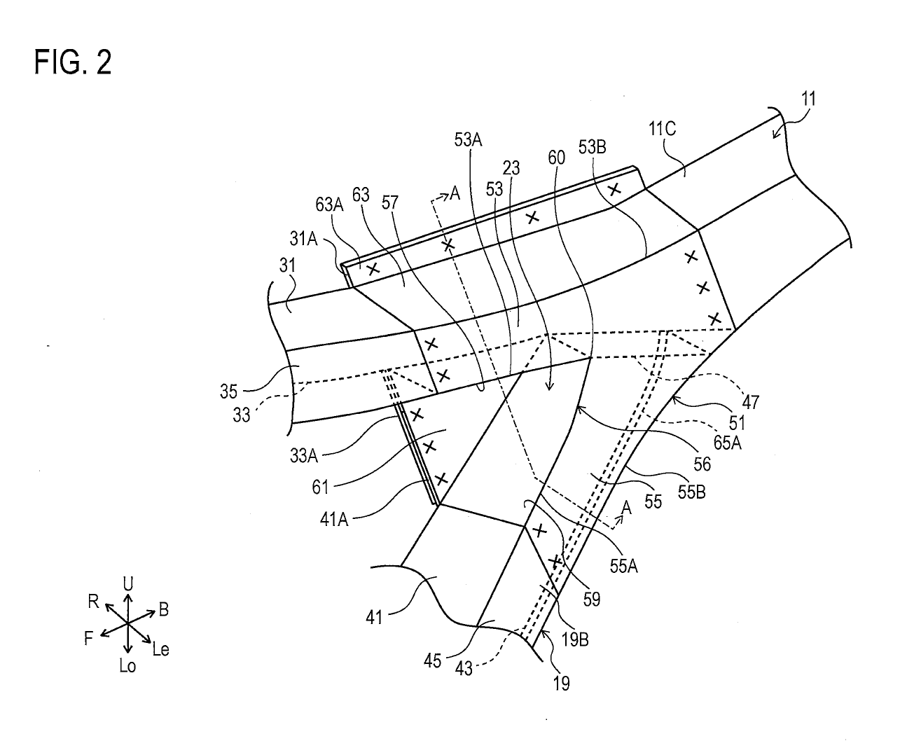

Next, a detailed structure of the coupling member 51 will be explained with reference to FIG. 2, FIG. 2 shows an enlarged view of the section where the coupling member 51 is provided in FIG. 1, In addition, a mark “X” in FIG. 2 indicates a welding portion by spot welding as an example. In addition, the cowl side 11, the lower member 19, and the coupling member 51 may be joined not only by welding, but by swaging or the like.

The cowl side 11 is opened by removing the inner side wall in the vehicle width direction, and is in the shape of a bottomed box which has an upper wall 31 and a lower wall 33 facing each other in the upper-lower direction, and a side wall 35 provided on the outside of the vehicle width direction. Likewise, the lower member 19 is opened by removing the inner side wall in the vehicle width direction, and is in the shape of a bottomed box which has an upper wall 41 and a lower wall 43 facing each other in the upper-lower direction, and a side wall 45 provided on the outside of the upper wall 41 front side member 12 externally in the vehicle width direction.

In the inner side portion of the substantially Y-shaped branch which is sandwiched between the cowl side 11 and the lower member 19, a groove section 23 is configured so that the distance in theupper-lower direction between the lower wall 33 of the cowl side 11 and the upper wall 41 of the lower member 19 gradually decreases from the front side section where the branch is expanded toward an intersection point 60 of the branch on the rear side. The upper end section 19B of the lower member 19 is opened at the rear wall on the rear side of the vehicle 10, and an the end section 47 having a substantially U-shaped cross section when taken in the width direction is fixed coming into contact with the lower wall 33 of the cowl side 11. In addition, the lower member 19 may be configured not to bring the end section 47 of the upper end section 19B into contact with the lower wall 33 of the cowl side 11, but to be fixed with a predetermined space from the lower wall 33. The lower wall 33 is shaped to be inclined downward along the shape of the end section 47 of the upper end section 19B from the intersection point 60 toward the rear. Furthermore, the lower wall 33 is formed toward the rear side of the vehicle so as to be approximately parallel with the upper wall 31 in the section further behind the coupling section to the end section 47. Consequently, the cowl side 11 has an extended width in theupper-lower direction from the intersection point 60 to the section where the end section 47 comes into contact with the lower wall 33, i.e., the width thereof is partially widened.

The coupling member 51 is shaped so that it covers the section where the cowl side 11 and the lower member 19 are branched in substantially Y-shape, and the branching section is provided with a first cover section 53 which covers the side wall 35 of the cowl side 11, and second cover section 55 which covers the side wall 45 of the lower member 19. The first cover section 53 and the second cover section 55 are connected to each other by a concave portion 56 at the groove section 23 that is the inner side portion of the branch. The concave portion 56 is formed along the shape of the groove section 23. The coupling member 51 is formed, for example, by press working a metal plate material, and the first cover section 53, the second cover section 55, and the concave portion 56 are integrally formed. The second cover section 55 continues to the first cover section 53 at the section where the end section 47 of the lower member 19 comes into contact with the lower wall 33 of the cowl side 11. The first cover section 53 is joined by spot welding to the side wall 35 at the end section in the front-back direction. Furthermore, the second cover section 55 is joined by spot welding to the side wall 45 at the end section on the front side in the front-back direction.

The concave portion 56 is provided with a first inner wall section 57, a second inner wall section 59, and a the bottom section 61. The first inner wall section 57 is formed continuously from the lower end section of the first cover section 53, that is, a side edge portion 53A of the first cover section 53 provided at the position as being the inner side portion of the branch in the width direction (the thickness direction) of the cowl side 11, and is formed toward the right side in the vehicle width direction. The side edge portion 53A is formed along a corner in the cowl side 11 formed by the side wall 35 and the lower wall 33. The first inner wall section 57 is formed along the lower wall 33 so as to entirely cover the lower wall 33 of the cowl side 11 in the groove section 23.

Likewise, the second inner wall section 59 is formed continuously from the upper end section of the second cover section 55, that is, a side edge portion 55A of the second cover section 55 provided at the position as being the inner side portion of the branch in the width direction (the thickness direction) of the lower member 19, and is formed toward the right side in the vehicle width direction. The side edge portion 55A is formed along a corner in the lower member 19 formed by the side wall 45 and the upper wall 41. The second inner wall section 59 is formed along the upper wall 41 so as to entirely cover the upper wall 41 of the lower member 19 in the groove section 23.

The bottom section 61 is provided so as to close the opening on the right side of the groove section 23 in the vehicle width direction. In other words, the bottom section 61 is provided at the depth side of the groove section 23 (the deepest position in the groove) in FIG. 2 to connect the first inner wall section 57 to the second inner wall section 59. The bottom section 61 is formed continuously from end section of each of the first inner wall section 57 and the second inner wall section 59, and is in the shape of substantially triangle when viewing from the vehicle width direction. In this manner, the concave portion 56 inserted into the groove section 23 is formed to connect the side edge portion 55A of the second cover section 55 to the side edge portion 53A of the first cover section 53 by the first inner wall section 57, the second inner wall section 59, and the bottom section 61.

A fixing plate portion 33A corresponding to the shape of the bottom section 61 is formed on the lower wall 33 of the cowl side 11. The fixing plate portion 33A is formed to be bent downward from the end section on the right side in the vehicle width direction of the lower wall 33. Furthermore, a fixing plate portion 41A corresponding to the shape of the bottom section 61 is formed on the upper wall 41 of the lower member 19. The fixing plate portion 41A is formed to be bent upward from the end section on the right side in the vehicle width direction of the upper wall 41. The fixing plate portion 33A and the fixing plate portion 41A are provided to overlap the bottom section 61, and are joined by spot welding to the bottom section 61.

Furthermore, the coupling member 51 has a first outer wall section 63 which covers the upper wall 31 of the cowl side 11, and a second outer wall section 65 which covers the lower wall 43 of the lower member 19 (see FIG. 3). FIG. 3 shows a cross section taking a line A-A in FIG. 2 seeing from the direction of an arrow. As shown in FIGS. 2 and 3, the first outer wall section 63 is formed continuously from a side edge portion 53B as being the upper end side of the first cover section 53, and is formed toward the right side in the vehicle width direction. The side edge portion 53B is formed along a corner in the cowl side 11 formed by the side wall 35 and the upper wall 31. The first outer wall section 63 is formed along the upper wall 31 so as to entirely cover the upper wall 31 of the cowl side 11.

The upper wall 31 has a flange portion 31A formed to be bent upward on the right side in the vehicle width direction. The flange portion 31A is formed toward the front-back direction with a predetermined width. Furthermore, the first outer wall section 63 is provided with a flange portion 63A in accordance with the shape of the flange portion 31A of the upper wall 31. As shown in FIG. 2, the flange portion 31A of the upper wall 31 and the flange portion 63A of the first outer wall section 63 are joined by spot welding.

Furthermore, the second outer wall section 65 is formed continuously from a side edge portion 55B as being the lower end side of the second cover section 55, and is formed toward the right side in the vehicle width direction. The side edge portion 55B is formed along a corner in the lower member 19 formed by the side wall 45 and the lower wall 43. The second outer wall section 65 is formed along the lower wall 43 so as to entirely cover the lower wall 43 of the lower member 19.

Furthermore, the lower wall 43 has a flange portion 43A formed to be bent downward on the right side in the vehicle width direction. The flange portion 43A is formed toward the front-back direction with a predetermined width. Furthermore, the second outer wall section 65 is provided with a flange portion 65A in accordance with the shape of the flange portion 43A of the lower wall 43. The flange portion 43A of the lower wall 43 and the flange portion 65A of the second outer wall section 65 are joined by spot welding.

As shown in FIG. 3, the coupling member 51 in Embodiment 1 is formed in the branching section in accordance with the shapes of the cowl side 11 and the lower member 19, and each of the members such as the first cover section 53, the flange portion 63A, the bottom section 61, etc., is joined to the cowl side 11 and the lower member 19. The joined coupling member 51 is fixed in close contact with the outer peripheral surface of the cowl side 11 and the lower member 19 (the side wall 35, etc.).

In addition, the cowl side 11 is an example of the first member. The lower member 19 is an example of the second member. The side edge portion 53A is an example of the first side edge portion. The side edge portion 55A is an example of the second side edge portion.

The effect described below will be provided by Embodiment 1 described above.

The first and second cover sections 53 and 55 are connected to each other at the branching section where the cowl side 11 and the lower member 19 are joined, by the concave portion 56 inserted into the groove section 23 which is the inner side portion of the branch. The concave portion 56 connects the side edge portion 53A on the side of the groove section 23 of the first cover section 53 to the side edge portion 55A on the side of the groove section 23 of the second cover section 55. The coupling member 51 closes the opening of the groove section 23 by the concave portion 56 which connects the first and second cover sections 53 and 55. Therefore, even if a load by an impact or the like in the direction away from the second cover section 55 (such as in the upper direction of the vehicle) is applied to the first cover section 53, for example, the impact applied from the side edge portion 53A of the first cover section 53 toward the side edge portion 55A of the second cover section 55 is transmitted via the concave portion 56, so that the load to be applied is not applied concentrically to the intersection point 60 at which the first and second cover sections 53 and 55 intersect with each other. Therefore, it is possible to prevent the branching section from being deformed or cracking, resulting in separation of the cowl side 11 and the lower member 19.

Furthermore, the bottom section 61 of the concave portion 56 is formed in the shape of a flat plate that closes the opening of the groove section 23, and connects the first inner wall section 57 to the second inner wall section 59. The fixing plate portion 33A corresponding to the shape of the bottom section 61 is formed on the lower wall 33 of the cowl side 11.

Furthermore, the fixing plate portion 41A corresponding to the shape of the bottom section 61 is formed on the upper wall 41 of the lower member 19. Then, the fixing plate portion 33A and the fixing plate portion 41A are joined by spot welding so as to overlap the bottom section 61. In such a structure, the bottom section 61 in the flat-plate manner makes it possible to easily and firmly fix the cowl side 11 and the lower member 19.

Furthermore, the coupling member 51 has the first outer wall section 63 which covers the upper wall 31 of the cowl side 11, and the second outer wall section 65 which covers the lower wall 43 of the lower member 19. The flange portion 31A of the upper wall 31 and the flange portion 63A of the first outer wall section 63 are joined by spot welding. Furthermore, the flange portion 43A of the lower wall 43 and the flange portion 65A of the second outer wall section 65 are joined by spot welding. Consequently, the coupling member 51 can fix the cowl side 11 and the lower member 19 more firmly by the first and second outer wall sections 63 and 65.

While the present invention has been explained above based on Embodiment 1, the present invention is not limited to Embodiment 1 described above, but a variety of improvements and modifications can be made without departing the spirit of the present invention.

For example, as shown in FIG. 3, Embodiment 1 described above includes the fixing plate portion 33A of the lower wall 33 and the fixing plate portion 41A of the upper wall 41 which are provided to be overlapped each other. However, the structure is not limited to this, but, as shown in FIG. 4, for example, the bottom section 61 may be configured so that the fixing plate portion 33A and the fixing plate portion 41A are joined at different positions. In the structure shown in FIG. 4, the fixing plate portion 33A has the width protruding toward the side of the lower member 19 that is smaller than that in Embodiment 1. Likewise, the fixing plate portion 41A has the width protruding toward the side of the cowl side 11 that is smaller than that in Embodiment 1. A gap is provided between the fixing plate portion 33A and the fixing plate portion 41A. Even in such a structure, it is possible to fix the cowl side 11 and the lower member 19 more firmly, similar to Embodiment 1.

### Embodiment 2

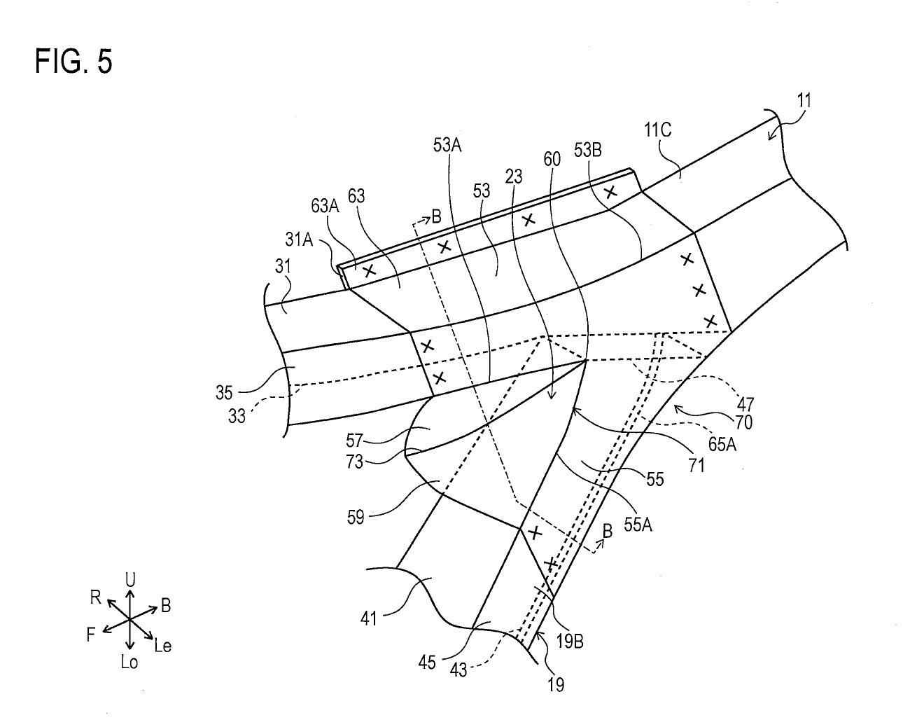

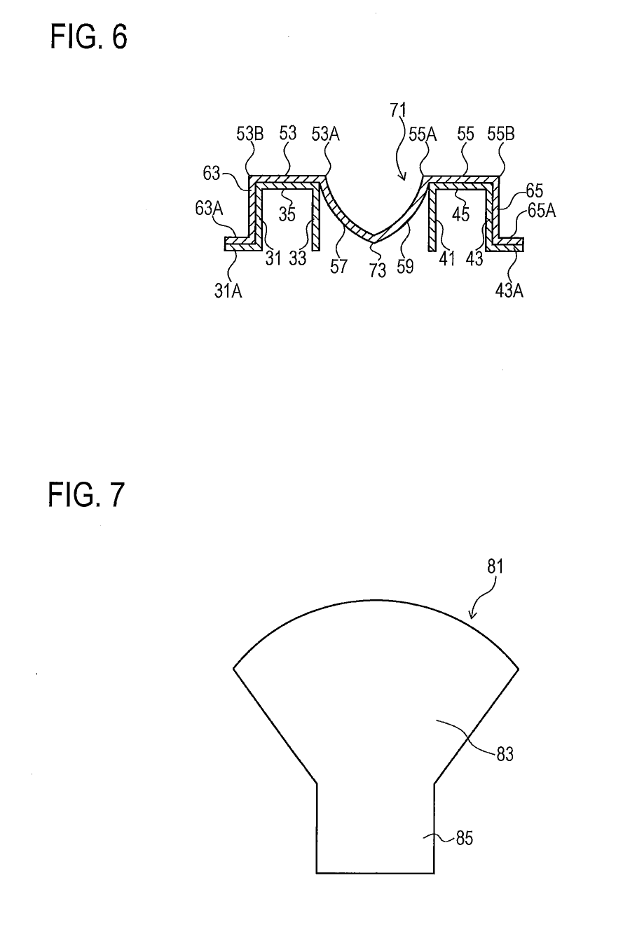

Next, Embodiment 2 will be explained which has the different structure from Embodiment 1. In Embodiment 1, the concave portion 56 is configured so that the first inner wall section 57 is formed along the lower wall 33, and the second inner wall section 59 is formed along the upper wall 41, however, the structure is not limited to this. For example, as shown in FIG. 5, a concave portion 71 may be in the curved shape. FIG. 5 is an enlarged view of a portion where a coupling member 70 is provided in Embodiment 2. FIG. 6 is a cross sectional view showing a cross section taking a line B-B in FIG. 5 seeing from the direction of an arrow. In addition, in the explanation below, like reference numerals refers to like components in Embodiment 1, and the explanations thereof will be omitted if not necessary.

As shown in FIGS. 5 and 6, in the concave portion 71, an inclining section 73 is formed which gradually inclines toward the depth direction of the groove section 23 which is the inner side portion of the branch, from the intersection point 60 which is a basal portion of the branch toward the front side of the vehicle which is a ramification side. The term “depth direction” used herein refers to the direction toward the right side in the vehicle width direction in the case shown in FIG. 5, whereas being the direction toward the lower side in the figure in the case shown in FIG. 6. The first and second inner wall sections 57 and 59 of the concave portion 71 are formed integrally across the inclining section 73. The concave portion 71 has the substantially U-shaped cross section when taken along the line B-B (see FIG. 6). The first inner wall section 57 is inclined from the side edge portion 53A of the first cover section 53 toward the inclining section 73. Different from Embodiment 1, there is provided a section spaced from the lower wall 33 of the cowl side 11. Likewise, the second inner wall section 59 is inclined from the side edge portion 55A of the second cover section 55 toward the inclining section 73, and there is provided a section spaced from the upper wall 41 of the lower member 19. While the detailed description will be made later, the coupling member 70 makes it easier to conduct press working compared to the coupling member 51 in Embodiment 1.

Next, the explanation will be made regarding an example of a method of manufacturing the coupling member 51 in Embodiment 1 and the coupling member 70 in Embodiment 2 shown in FIG. 5 with reference to FIGS. 7 to 10. The explanation will be made regarding the manufacturing steps of forming the coupling member 70 by press working a fan-shaped metal plate material 81 shown in FIG. 7, for example. As shown in FIG. 7, the metal plate material 81 has a fan-shaped section 83 having the shape of a fan in a plan view, and a rectangular section 85 which is formed integrally on the inner periphery of the fan-shaped section 83.

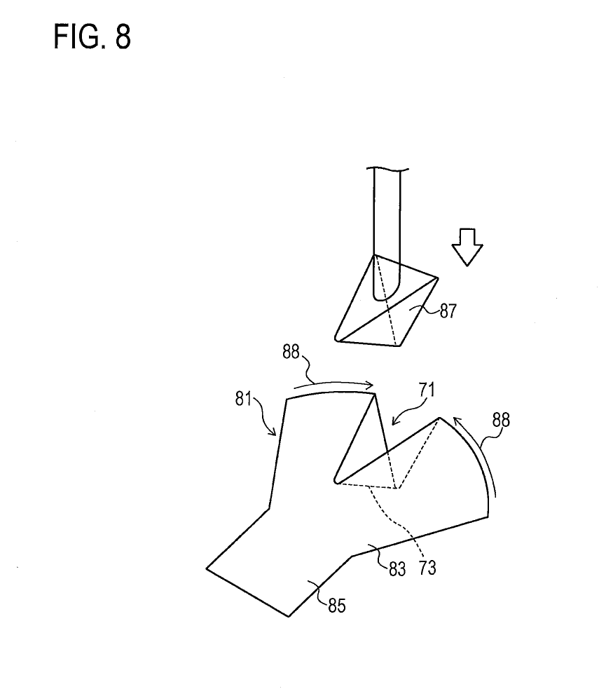

As shown in FIG. 8, the metal plate material 81 is put on a lower die (not shown) so that an arc-shaped part of the fan-shaped section 83 is press worked by an upper die 87. In the example shown in FIG. 8, the upper die 87 is pressed against the center area of the circumference of the fan-shaped section 83. The upper die 87 has the convex shape corresponding to the shape of the concave portion 71 of the coupling member 70 in Embodiment 2 shown in FIG. 5. Here, at the time of press working the metal plate material 81 by the upper die 87, it may be preferable that the metal plate material 81 is not fixed. For example, the groove section 23 that is the branching section between the cowl side 11 and the lower member 19 in Embodiment 1 takes the form of an sharp angle. If it is intended to form the concave portion 71 to be inserted into the groove section 23 deeper, the angle of the concave portion 71 becomes acute. Therefore, it is difficult at the time of press working to form the acute concave portion 71 by stretching only a part to be the concave portion 71 by the upper die 87 while fixing the metal plate material 81 to the lower die. Then, in the method for manufacturing concerned, a part of the fan-shaped section 83 is press worked by the upper die 87 without fixing the fan-shaped section 83 of the metal plate material 81. In the present method for forming, the fan-shaped section 83 of the metal plate material 81 is moved so as to be pulled toward the central area of the circumference depressed by the upper die 87, as indicated by an arrow 88 in FIG. 8. Therefore, in the metal plate material 81, the portion depressed by the upper die 87 is stretched, while the fan-shaped section 83 is moved so as to be pulled by upper die 87. This reduces the load to be applied to the metal plate material 81, compared to the case of stretching only a part of the material while being fixed to the lower die. This makes it possible to manufacture the concave portion 71 having an acute angle with high accuracy.

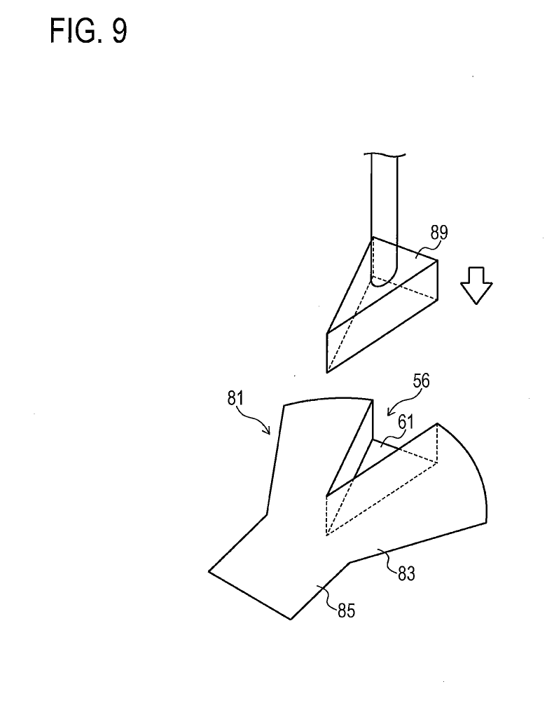

As shown in FIG. 8, press working of the concave portion 71 of the coupling member 70 in Embodiment 2 shown in FIG. 5 becomes feasible by a method in which the fan-shaped section 83 is not fixed. However, in the concave portion 56 of the coupling member 51 in Embodiment 1, the first inner wall section 57 is formed along the lower wall 33, and the second inner wall section 59 is formed along the upper wall 41, so that it becomes necessary to form the first and second inner wall sections 57 and 59 which are acuter than the concave portion 71 of the coupling member 70 shown in FIG. 5. Therefore, if it is difficult to manufacture the acute concave portion 56 like the groove section 23 having a sharp angle it can be considered that once the concave portion 71 having the inclining section 73 is formed on the metal plate material 81, and then the metal plate material 81 is again press worked, thereby forming the concave portion 56 in Embodiment 1, as shown in FIG. 9. In the manufacturing method concerned, one more step of press working is necessary to form the concave portion 56 in Embodiment 1 compared to the case of forming the concave portion 71 show in FIG. 5. In other words, it can be said that the manufacturing of the coupling member 70 shown in FIG. 5 can reduce the step of press working compared to manufacturing of the coupling member 51, thereby achieving facilitation. In addition, it of course may be possible to form the coupling member 51 having the concave portion 56 by press working one time to the metal plate material 81 if it is formable. Furthermore, the concave portion 56 and the concave portion 71 may be formed by drawing in which the metal plate material 81 is fixed to the lower die.

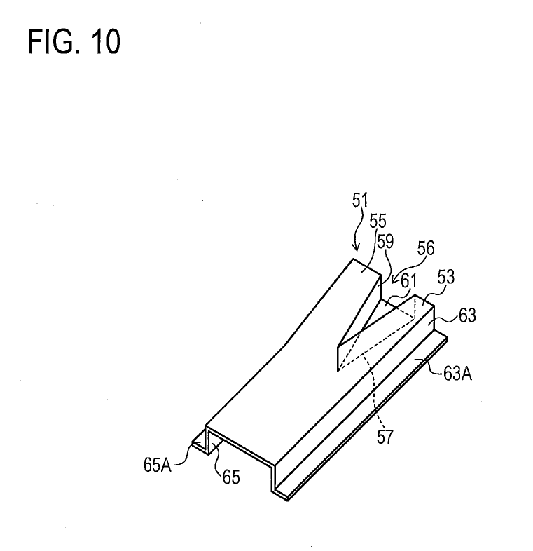

As shown in FIG. 9, the metal plate material 81 is put on a lower die (not shown) so that the section of the fan-shaped section 83 where the concave portion 71 is formed is press worked by an upper die 89. The upper die 89 has the convex shape corresponding to the shape of the concave portion 56 of the coupling member 51 in Embodiment 1. The press working concerned may not require fixing the fan-shaped section 83 of the metal plate material 81 fixed to the lower die. Thereby, the concave portion 56 having the bottom section 61 is formed in the metal plate material 81. Then, the metal plate material 81 after press worked shown in FIG. 9 is subjected to press working corresponding to the first outer wall section 63 and the flange portion 63A, and thus it is possible to form the coupling member 51 shown in FIG. 10. In addition, press working of the first outer wall section 63 and the flange portion 63A is conducted by bending, for example. In this manner, it becomes possible to manufacture the coupling member 51 in Embodiment 1. Likewise, the metal plate material 81 on which the concave portion 71 is formed as shown in FIG. 8 is subjected to press working corresponding to the first outer wall section 63 and the flange portion 63A, and thus it becomes possible to form the coupling member 70.

Furthermore, while Embodiment 1 described above explains taking the cowl side 11 and the lower member 19 as the example of the first and second member coupled by the coupling member 51, the coupling member of the present application can be applied to any other coupling portions. More specifically, irrespective of the structure of the vehicle front section, it is possible to apply the coupling member 51 for coupling a variety of branching sections of frames of the vehicle, such as the rear structure.

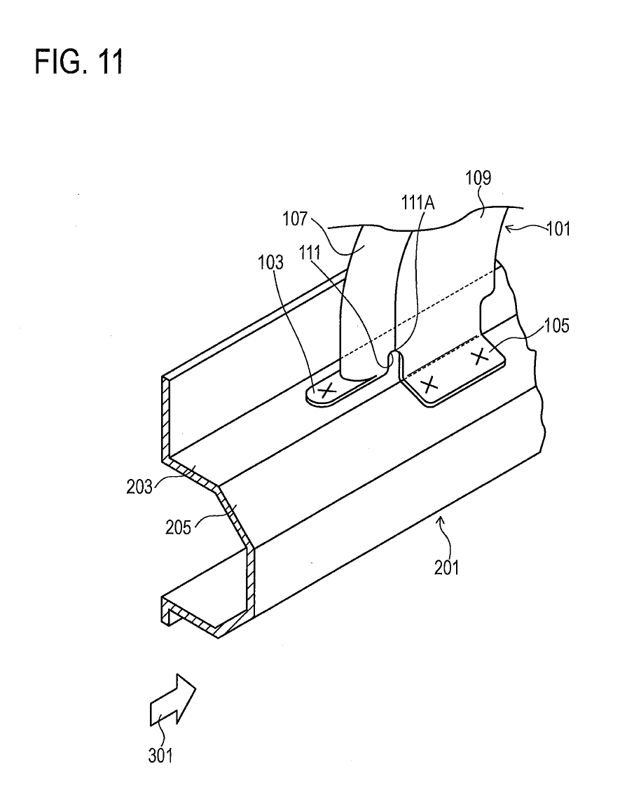

Furthermore, in Embodiment 1 described above, the coupling member 51 is structured to have the concave portion 56 inserting into the groove section 23 of the branching section, however, the structure is not limited to this. For example, the coupling member of the present application may be in the shape for only entirely covering the branching section between the cowl side 11 and the lower member 19. More specifically, the coupling member 51 may be structured so that the first and second cover sections 53 and 55 are formed in the shape of a single plate, without providing the concave portion 56, the first outer wall section 63, and the second outer wall section 65. Then, the first and second cover sections 53 and 55 are joined by welding or the like to the side wall 35 of the cowl side 11 or the side wall 45 of the lower member 19. Even in such a structure, it is possible to join two members without the necessity of flange portions 103 and 105 having a notch 111 provided therebetween as shown in FIG. 11.

Furthermore, in Embodiment 1 described above, two members (the cowl side 11 and the lower member 19, etc.) may be joined using the flange portions 103 and 105 having the notch 111 provided therebetween as shown in FIG. 11, as well as joined by means of the coupling member 51. Thereby, it is possible to fix the cowl side 11 and the lower member 19 more firmly while suppressing cracking or the like in the notch 111 by the coupling member 51.

Furthermore, in each of the embodiments described above, the first and second cover sections 53 and 55 may be structured to be connected only by the concave portion 56. More specifically, in each of the embodiments, while the second cover section 55 is formed continuously to the first cover section 53 at the section where the end section 47 of the lower member 19 comes into contact with the lower wall 33 of the cowl side 11, the section concerned may be structured to be discontinued. In this case, for example, each of the first and second cover sections 53 and 55 is arranged in the vehicle upper-lower direction, and is coupled by the concave portion 56 provided between the upper-lower direction so as to be integrally formed.

According to the technique disclosed in the present application, it is possible to provide a coupling member capable of fixing a branching section more firmly which couples frame members of a vehicle to each other.

What is claimed is:

1. A coupling member of vehicle frame for coupling a first member extending in the first direction to a second member extending in the second direction different from the first direction, comprising:
a first cover section covering the first member;
a second cover section covering the second member; and
a concave portion connecting two side edge portions, that is, a first side edge portion and a second side edge portion, in a branching section coupling the first member to the second member,
wherein the concave portion inserted in an inner portion of a branch sandwiched between the first and second members, the first side edge portion provided in the first cover section and provided at the position as being an inner side portion of the branch in the width direction of the first member, the second side edge portion provided in the second cover section and provided at the position as being an inner side portion of the branch in the width direction of the second member.

2. The coupling member according to claim 1, wherein the concave portion is formed in a flat plate shape, and has a bottom section to be joined to at least one of the first and second members.

3. The coupling member according to claim 1, wherein the concave portion has an inclining section gradually inclining toward the depth direction in the inner portion of the branch as it is closer from a basal portion side of the branch to a ramification side.

4. The coupling member according to claims 1 comprising:
a first outer wall section connected to the first cover section, and covering the outer periphery of the first member in the outer section of the branch; and
a second outer wall section connected to the second cover section, and covering the outer periphery of the second member in the outer section of the branch.

5. The coupling member according to claims 1, wherein the concave portion for connecting the first cover section and the second cover section is formed from a fan-shaped metal plate material by press working without fixing an arc-shaped portion of the fan-shaped metal plate material.
